(19) United States
(12) Patent Application Publication
(10) Pub. No.: US 2019/0225791 A1
(43) Pub. Date: Jul. 25, 2019

(54) VINYLIDENE FLUORIDE POLYMER

(71) Applicant: SOLVAY SPECIALTY POLYMERS ITALY S.P.A., Bollate (IT)

(72) Inventors: Julio A. ABUSLEME, Saronno (IT); Ségolène BRUSSEAU, Tavaux (FR)

(21) Appl. No.: 16/340,044

(22) PCT Filed: Oct. 3, 2017
(86) PCT No.: PCT/EP2017/075048

§ 371 Date: Apr. 5, 2019

(30) Foreign Application Priority Data
Oct. 5, 2016 (EP) 16306305.0

(51) Int. Cl. C08L 27/16; C08F 14/22

(52) U.S. Cl. CPC C08L 27/16; C08L 2203/18; C08L 2203/16; C08F 14/22

(57) ABSTRACT

The present invention pertains to a process for manufacturing a vinylidene fluoride polymer, to the vinylidene fluoride polymer obtained by said process and to uses of said vinylidene fluoride polymer in various applications.

### CROSS-REFERENCE TO RELATED APPLICATION

This application claims priority to European application No. 16306305.0 filed Oct. 5, 2017, the whole content of this application being incorporated herein by reference for all purposes Technical Field

The present invention pertains to a process for manufacturing a vinylidene fluoride polymer, to the vinylidene fluoride polymer obtained by said process and to uses of said vinylidene fluoride polymer in various applications.

### BACKGROUND ART

The semiconductor and food industries require articles made of polymers such as fluoropolymers, in particular vinylidene fluoride polymers, bearing higher purity and higher performances, especially improved mechanical strength.

Vinylidene fluoride polymers are typically manufactured by suspension polymerization or emulsion polymerization processes.

For instance, U.S. Pat. No. 5,283,302 (KUREHA CHEMICAL INDUSTRY CO., LTD.) 01.02.1994 discloses a process for manufacturing vinylidene fluoride polymers having fine spherulites, said process being carried out by suspension polymerization in an aqueous medium, said process comprising adding a chain transfer agent when polymerization conversion rate reaches 10-50%.

Also, EP 2196479 A (KUREHA CORPORATION) 16.06.2010 discloses a process for manufacturing vinylidene fluoride polymer powders having a high molecular weight, said process being carried out by supercritical suspension polymerization in an aqueous medium comprising, inter alia, a suspension agent, a chain transfer agent and a polymerization initiator.

However, there is still the need in the art for articles made of vinylidene fluoride polymers exhibiting a higher purity and a higher thermal stability, in combination with a higher mechanical strength, to be suitably used in various applications, including semiconductor and food applications.

EP 0626396 A (AUSIMONT SPA) 30.11.1994 is directed to an emulsion-polymerization process whereas an alkali metal salt (a perfluorooctanoate salt) is used as surfactant (see Ex. 1), and wherein a chain transfer agent is fed into the reactor either continuously or in discrete amounts during the polymerization.

U.S. Pat. No. 3,714,137 (SUEDDEUTSCHE KALKSTICKSTOFF-WERKE) 30.01.1973 discloses the polymerization of vinylidene fluoride at an acidic pH and in the presence of a peroxydisulfate polymerization initiator; the pH value of the aqueous reaction medium may be adjusted by any acid which is inert to the reaction, and preferred pH range is between 4 and 6. Preferred acids are boric acid, sulfuric acid and hydrochloric acid. The preferred initiators are ammonium peroxydisulfate and potassium peroxydisulfate.

WO 2012/030784 (ARKEMA) 08.03.2012 is directed to a method of producing fluoropolymers using acid-functionalized monomers; more specifically, it pertains to a process for preparing a fhioropolymer in an aqueous reaction medium, comprising: a) forming an aqueous emulsion comprising at least one radical initiator, at least one acid-functionalized monomer or salt thereof (preferably ammonium or sodium salts), and at least one fluoromonomer, typically vinylidene fluoride, and b) initiating polymerization of said at least one fluoromonomer. Chain-transfer agents are added to the polymerization to regulate the molecular weight of the product. They may be added to a polymerization in a single portion at the beginning of the reaction, or incrementally or continuously throughout the reaction. Buffering agents may comprise an organic or inorganic acid or alkali metal salt thereof, or base or salt of such organic or inorganic acid, that has at least one pKa value in the range of from about 4 to about 10, preferably from about 4.5 to about 9.5. Preferred buffering agents described in this document include, for example, phosphate buffers and acetate buffers.

### SUMMARY OF INVENTION

It has been now found that a vinylidene fluoride polymer may be easily obtained by the process of the invention.

In a first instance, the present invention pertains to a process for manufacturing a vinylidene fluoride (VDF) polymer [polymer (VDF)], said process comprising polymerizing vinylidene fluoride (VDF) and, optionally, at least one fluorinated monomer different from VDF in an aqueous medium having a pH of at least 4, said aqueous medium comprising, preferably consisting of:
water,
at least one salt comprising at least one alkaline metal cation [salt (AM)], said salt (AM) being free from one or more protons (H⁺), and
optionally, at least one suspending agent, in the presence of at least one radical initiator and at least one chain transfer agent, wherein said at least one chain transfer agent is added to said aqueous medium prior to or together with said at least one radical initiator.

The aqueous medium advantageously has a pH of at least 4, preferably of at least 5, more preferably of at least 6, even more preferably of at least 7.

For the purpose of the present invention, the term “salt comprising at least one alkaline metal cation [salt (AM)]” is intended to denote a chemical compound formed from the reaction of an acid with a base, wherein all the hydrogen ions (protons) of the acid are replaced by alkaline metal cation(s).

The salt (AM) typically comprises at least one alkaline metal cation and an organic or inorganic anion. The alkaline metal cation is typically selected from the group consisting of Li⁺, Na⁺ and K⁺ cations.

The salt (AM) preferably comprises at least one Na⁺ cation.

The salt (AM) is preferably selected from the group consisting of tetrasodium pyrophosphate (TSPP) of formula Na₄(P₂O₇), Na₃PO₄, Na₂ CO₃ and mixtures thereof.

The salt (AM) is more preferably tetrasodium pyrophosphate (TSPP) of formula Na₄(P₂O₇).

The aqueous medium is advantageously free from one or more salts comprising one or more protons (H⁺).

The aqueous medium typically comprises at least one salt (AM) in an amount comprised between 0.05 and 5 g/Kg of water, preferably between 0.1 and 2 g/Kg of water, more preferably between 0.3 and 0.8 g/Kg of water.

The amount of at least one Na⁺ cation in the aqueous medium is typically comprised between 0.02 and 10 g/Kg of water, preferably between 0.05 and 5 g/Kg of water, more preferably between 0.1 and 1 g/Kg of water.

Should the salt (AM) be tetrasodium pyrophosphate (TSPP) of formula Na₄(P₂O₇), the amount of (P₂O₇)⁴⁻ anion in the aqueous medium is typically comprised between 0.005 and 10 g/Kg of water, preferably between 0.05 and 5 g/Kg of water, more preferably between 0.1 and 1.0 g/Kg of water.

Should the salt (AM) be Na₃PO₄, the amount of (PO₄)³⁻ anion in the aqueous medium is typically comprised between 0.001 and 15 g/Kg of water, preferably between 0.05 and 10 g/Kg of water, more preferably between 0.2 and 2.0 g/Kg of water.

The aqueous medium preferably comprises, more preferably consists of:
water,
at least one salt comprising at least one alkaline metal cation [salt (AM)], said salt (AM) being free from one or more protons (H⁺), and
at least one suspending agent.

The suspending agent is preferably selected from the group consisting of polysaccharide derivatives.

For the purpose of the present invention, the term “polysaccharide derivative” is intended to denote a derivative of a polysaccharide polymer comprising as recurring units one or more glycosidic units linked to each other by glycosidic bonds.

Glycosidic units are hereby intended to denote either six-membered pyranoside rings or five-membered furanoside rings.

Non-limiting examples of suitable six-membered pyranosides include, notably, D-glucopyranosides such as α-D-glucopyranosides or β-D-glucopyranosides.

Non-limiting examples of suitable five-membered furanosides include, notably, D-glucofuranosides.

Unless otherwise specified, the dynamic viscosity of the polysaccharide derivatives is measured according to ASTM D445 at 20° C. in an aqueous solution at a concentration of 2% by weight.

The polysaccharide derivative preferably has a dynamic viscosity comprised between about 1 and about 30000 mPa·s, preferably between about 3 and about 21000, more preferably between about 50 and about 15000, even more preferably between about 80 and about 13000 mPa·s, still more preferably between about 120 and about 11250 mPa·s, as measured according to ASTM D445 at 20° C. in an aqueous solution at a concentration of 2% by weight.

The polysaccharide derivative more preferably has a dynamic viscosity comprised between about 2.4 and about 3.6 mPa·s, preferably between about 80 and about 120 mPa·s, more preferably between about 11250 and about 21000 mPa·s, as measured according to ASTM D445 at 20° C. in an aqueous solution at a concentration of 2% by weight.

The polysaccharide derivative preferably comprises glycosidic units selected from D-glucopyranosides and D-glucofuranosides, or a mixture thereof, linked to each other by glycosidic bonds.

The polysaccharide derivative more preferably comprises one or more β-D-glucopyranosides units of formula (I) here below, linked to each other by β-glycosidic bonds:

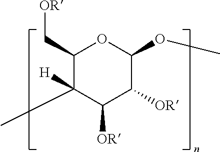

wherein each R′, equal to or different from any other at each occurrence, represents a hydrogen atom, a C₁-C₈ hydrocarbon group or a C₂-C₈ hydroxyalkyl group, preferably a hydrogen atom, a methyl group, a hydroxyethyl group or a 2-hydroxypropyl group.

The polysaccharide derivative is preferably selected from the group consisting of methylcellulose, hydroxyethyl methylcellulose or 2-hydroxypropyl methylcellulose, the latter being particularly preferable.

The polysaccharide derivative is more preferably a hydroxypropyl methylcellulose, wherein the methoxyl degree of substitution (i.e. the average number per mole of groups R′, wherein R′ is a methyl group in formula (I), with respect to the total number of groups R′) is about 1.2 to 1.6 (e.g. 1.4) and/or the hydroxypropyl degree of substitution (i.e. the average number per mole of groups R′, wherein R′ is a 2-hydroxypropyl group in formula (I), with respect to the total number of groups R′) is about 0.15 to 0.25 (e.g. 0.21).

As non-limiting examples, the hydroxypropyl methylcellulose in the process of the invention has a dynamic viscosity comprised between about 80 and about 120 mPa·s or between about 11250 and about 21000 mPa·s at 20° C. in an aqueous solution at a concentration of 2% by weight.

Non-limiting examples of polysaccharide derivatives suitable for use in the process of the invention include, notably, cellulose derivatives available under the trademark names METHOCEL® K100, having a dynamic viscosity of 80 to 120 mPa·s at 20° C. in an aqueous solution at a concentration of 2% by weight, METHOCEL® K15M, having a dynamic viscosity of 11250 to 21000 mPa·s at 20° C. in an aqueous solution at a concentration of 2% by weight, METHOCEL® K3, having a dynamic viscosity of 2.4 to 3.6 mPa·s at 20° C. in an aqueous solution at a concentration of 2% by weight, METHOCEL® K4M, having a dynamic viscosity of 3000 to 6000 mPa·s at 20° C. in an aqueous solution at a concentration of 2% by weight and CULMINAL® MHPCS having a dynamic viscosity of 4 to 8 mPa×s at 20° C. in an aqueous solution at a concentration of 2% by weight.

The suspending agent is typically used in the process of the invention in an amount comprised between 0.01 and 2.0 g/Kg of total monomers, preferably between 0.1 and 1.0 g/Kg of total monomers.

While the choice of the radical initiator is not particularly limited, it is understood that those initiators suitable for use in the process of the invention are selected from compounds capable of initiating and/or accelerating the polymerization process.

The radical initiator is preferably selected from the group consisting of organic radical initiators.

Non-limiting examples of suitable organic radical initiators include, but are not limited to, acetylcyclohexanesulfonyl peroxide; diacetylperoxydicarbonate; dialkylperoxydicarbonates such as diethylperoxydicarbonate, dicyclohexylperoxydicarbonate, di-2-ethylhexylperoxydicarbonate; tert-butylperneodecanoate; 2,2′-azobis(4-methoxy-2,4dimethylvaleronitrile; tert-butylperpivalate; tert-amylperpivalate; dioctanoylperoxide; dilauroyl-peroxide; 2,2′-azobis (2,4-dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis (tert-butylperoxy)butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

The chain transfer agent is preferably of formula (II):

R₁—(O)ₓ—CO—(O)_{y}—R₂ (II)

wherein:
R₁ and R₂, equal to or different from each other, are C₁-C₁₀ alkyl groups, preferably C₁-C₅ alkyl groups, and
x and y, equal to or different from each other, are equal to 0 or 1.

The chain transfer agent is typically selected from the group consisting of:

(i) organic carbonates of formula (II-a):

R′₁—O—CO—O—R′₂ (II-a)

wherein R′₁ and R′₂, equal to or different from each other, are C₁-C₁₀ alkyl groups, preferably C₁-C₅ alkyl groups, and

(ii) alkyl acetates of formula (II-b):

R″₁—CO—CH₃ (II-b)

wherein R″₁ is a C₁-C₁₀ alkyl group, preferably a C₁-C₅ alkyl group.

Non-limiting examples of organic carbonates of formula (II-a) include, for instance, dimethyl carbonate, diethyl carbonate, dipropyl carbonate and pyroethyl carbonate.

Non-limiting examples of alkyl acetates of formula (II-b) include, for instance, ethyl acetate and isopropyl acetate.

The chain transfer agent is typically used in the process of the invention in an amount comprised between 5 and 100 g/Kg of total monomers, preferably between 15 and 50 g/Kg of total monomers.

The process of the invention is typically carried out by suspension polymerization or by supercritical suspension polymerization.

The process of the invention is typically carried out at a temperature of at least 10° C., preferably of at least 25° C., more preferably of at least 45° C.

The process of the invention is typically carried out at a temperature of at most 80° C., preferably of at most 75° C., more preferably of at most 70° C.

The process of the invention is typically carried out at a pressure of at least 25 bar, preferably of at least 60 bar, more preferably of at least 90 bar.

The process of the invention typically further comprises separating the polymer (VDF) thereby provided, typically by filtration, from the aqueous medium.

The polymer (VDF) obtained by the process of the invention is typically dried, typically at a temperature comprised between 30° C. and 120° C., preferably between 50° C. and 90° C.

The skilled in the art will understand that a shorter residence time will be required at a higher temperature. The polymer (VDF) obtained by the process of the invention is typically dried, typically at a temperature comprised between 50° C. and 90° C., usually for a residence time of at least one hour.

In a second instance, the present invention pertains to a vinylidene fluoride (VDF) polymer [polymer (VDF)] comprising recurring units derived from vinylidene fluoride (VDF) and, optionally, at least one fluorinated monomer different from VDF, said polymer (VDF) comprising recurring units derived from one or more head-to-head or tail-to-tail VDF-VDF dyads.

The polymer (VDF) of the invention typically comprises recurring units derived from one or more head-to-tail VDF-VDF dyads and one or more head-to-head or tail-to-tail VDF-VDF dyads.

For the purpose of the present invention, the term “head-to-tail VDF-VDF dyads” is intended to denote dyads of formula —CH₂CF₂—CH₂CF₂—, whereas the term “head-to-head or tail-to-tail VDF-VDF dyads” is intended to denote reversed dyads of formula —CF₂CH₂—CH₂CF₂—.

The polymer (VDF) of the invention preferably comprises recurring units derived from one or more head-to-head or tail-to-tail VDF-VDF dyads in an amount of less than 4.5%, with respect to the total amount of recurring units of polymer (VDF).

It has been found that the polymer (VDF) of the invention, due to a low amount of defects in the main chain as shown by an amount of reversed VDF-VDF dyads of less than 4.5% with respect to the total amount of recurring units in said polymer (VDF), is surprisingly endowed with enhanced mechanical properties.

On the other side, it has been found that a higher amount of chain defects in the polymer leads to a lower melting point of said polymer and to corresponding lower tensile properties such as lower values of elastic modulus.

The amount of head-to-tail, head-to-head and tail-to-tail VDF-VDF dyads in the polymer (VDF) can be measured by any suitable procedures, preferably using ¹⁹F-NMR analysis as described in RUSSO, S., et al. Synthesis and microstructural characterization of low-molar-mass poly(vinylidene fluoride). Polymer. 1993, vol. 34, no. 22, p. 4777-4781.

The polymer (VDF) of the invention is advantageously obtainable by the process of the invention.

The polymer (VDF) obtained by the process of the invention is typically in the form of powder particles.

The polymer (VDF) obtained by the process of the invention may be further processed by melt-processing techniques thereby providing pellets.

The polymer (VDF) is advantageously used in the form of pellets.

It has been surprisingly found that the polymer (VDF) of the invention has very low values of Total Organic Content (TOC).

The polymer (VDF) of the invention advantageously has values of TOC lower than 10 mg/Kg of said polymer (VDF), preferably lower than 9 mg/Kg of said polymer (VDF), more preferably lower than 8 mg/Kg of said polymer (VDF).

The Total Organic Content (TOC) in the polymer (VDF) can be measured by any suitable procedures, typically using said polymer (VDF) in the form of pellets.

The polymer (VDF) advantageously has an intrinsic viscosity comprised between 0.06 and 0.13 l/g, preferably between 0.07 and 0.12 l/g, more preferably between 0.08 and 0.11 l/g.

The intrinsic viscosity of the polymer (VDF) can be measured by any suitable procedures. The intrinsic viscosity of the polymer (VDF) is typically measured at 25° C. in N,N-dimethyl formamide.

The polymer (VDF) of the invention advantageously has values of White Index (WI) higher than 50, preferably higher than 53, more preferably higher than 55, as measured according to ASTM E313-96.

The polymer (VDF) of the invention preferably comprises at least 50% by moles, preferably at least 75% by moles, more preferably at least 95% by moles of recurring units derived from vinylidene fluoride (VDF) and, optionally, at least one fluorinated monomer different from VDF.

The polymer (VDF) of the invention may further comprise recurring units derived from at least one hydrogenated monomer.

For the purpose of the present invention, the term “fluorinated monomer” is intended to denote an ethylenically unsaturated monomer comprising at least one fluorine atom.

For the purpose of the present invention, the term “hydrogenated monomer” is intended to denote an ethylenically unsaturated monomer comprising at least one hydrogen atom and free from fluorine atoms.

Should the fluorinated monomer comprise at least one hydrogen atom, it is designated as hydrogen-containing fluorinated monomer.

Should the fluorinated monomer be free of hydrogen atoms, it is designated as per(halo)fluorinated monomer.

The fluorinated monomer may further comprise one or more other halogen atoms (Cl, Br, I).

Non-limiting examples of suitable fluorinated monomers include, notably, the followings:
C₂-C₈ perfluoroolefins such as tetrafluoroethylene and hexafluoropropylene (HFP);
C₂-C₈ hydrogenated fluoroolefins such as vinyl fluoride, 1,2-difluoroethylene and trifluoroethylene;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins such as chlorotrifluoroethylene;
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form; and
fluorodioxoles, preferably perfluorodioxoles.

The polymer (VDF) of the invention preferably comprises:
at least 95% by moles of recurring units derived from vinylidene fluoride (VDF) and
at most 5% by moles of recurring units derived from at least one fluorinated monomer different from VDF, preferably hexafluoropropylene (HFP).

In a third instance, the present invention pertains to an article comprising at least one polymer (VDF) of the invention.

The article of the invention is typically selected from the group consisting of films, plaques, pipes and fittings.

In a fourth instance, the present invention pertains to a process for manufacturing an article, said process comprising processing at least one polymer (VDF) of the invention or a composition comprising at least one polymer (F) of the invention into said article or a part thereof.

The article of the invention is typically obtainable by the process of the invention.

The article of the invention is typically obtainable by processing in molten phase at least one polymer (VDF) of the invention or a composition comprising at least one polymer (VDF) of the invention.

The invention will be now described in more detail with reference to the following examples whose purpose is merely illustrative and not limitative of the scope of the invention.

Determination of Intrinsic Viscosity of Polymer (VDF)

Intrinsic viscosity (η) [dl/g] was measured using the following equation on the basis of dropping time, at 25° C., of a solution obtained by dissolving the polymer (VDF) in N,N-dimethyl formamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and r is an experimental factor, which for polymer (VDF) corresponds to 3.

Determination of Total Organic Content (TOC) on Pellets of Polymer (VDF)

A clean glass bottle containing 50 g of pellets of polymer (VDF) was filled with ultrapure water and left to stand for two minutes. The water was then drained. This procedure was repeated ten times.

The container was then filled with 50 ml of ultrapure water and capped for the leaching test in an oven for 7 days at 85° C.

Each sample of pellets was leached in duplicate. After seven days leaching, the TOC value (mg/Kg) in the solutions so obtained was measured with a Shimadzu apparatus model TOC-L. The Total Carbon (TC) was measured and the value of Total Inorganic Carbon (TIC) was subtracted in order to obtain the TOO value on these pellets. The values set forth in Table 1 represent the average of the values on two samples of the same product obtained after the leaching-out test.

Determination of Reversed VDF-VDF Dyads in Polymer (VDF)

The total inversions per chain was evaluated by using ¹⁹F NMR analysis as described in RUSSO, S., et al. Synthesis and Microstructural Characterization of Low Molar Mass Polyvinylidene Fluoride. Polymer. 1993, vol. 34, no. 22, p. 77781.

Accordingly, the amount of units derived from one or more head-to-head or tail-to-tail VDF-VDF dyads is expressed in mole %, with respect to the total amount of recurring units.

Determination of White Index (WI) on Pellets of Polymer (VDF)

White Index (WI) was measured on pellets of polymer (VDF) according to ASTM E313-96 using a colorimeter commercially available as Minolta® CR410.

General Procedure for the Manufacture of Polymer (VDF) of any of Examples 1-4 According to the Invention

A sequence of 2420 g of demineralized water, a salt as described in Table 1 and 0.64 g of METHOCEL® K100 cellulose ether as suspending agent were introduced in a 4 liter reactor.

The mixture was stirred with an impeller running at a speed of 880 rpm. The reactor was purged with a sequence of vacuum (30 mmHg) and N₂ (fixed at 1 bar) at a fixed temperature of 20° C. This sequence was done 3 times.

A chain transfer agent (CTA) (diethyl carbonate or ethyl acetate) as described in Table 1 and 1.12 g of t-amyl perpivalate as radical initiator were then added to the reactor. The amount of the chain transfer agent was calculated in order to obtain a viscosity of the polymer around 0.10 l/g in DMF at 25° C.

1070 g of initial VDF were introduced in the mixture. The reactor was gradually heated until the first set-point temperature fixed at 52° C. At this temperature, the pressure was fixed at 120 bar. The pressure was kept constantly equal to 120 bar by feeding in total 250 g of VDF during the polymerization. After this feeding, no more monomer was added and the pressure was decreased to 90 bar. The reactor was then gradually heated to 67° C. The pressure was kept at 80 bar and 285 g of VDF were fed to the reactor. The pressure was then decreased down to 55 bar. A conversion of about 80-90% of VDF was reached. The polymerization was stopped by degassing the reactor until reaching the atmospheric pressure. The polymer (VDF) was collected by filtration and washed with demineralized water. After the washing step, the polymer powder was dried at 65° C. overnight.

The melting point of the polymer (VDF) so obtained was in the range of 171° C. to 173° C.

The process conditions for each of the polymers (VDF) of Examples 1 to 4 according to the invention are set forth in Table 1.

### COMPARATIVE EXAMPLE 1

The same procedure as detailed hereinabove for the manufacture of the polymers (VDF) of any of Examples 1-4 according to the invention was repeated but without using Na₄(P₂O₇) (TSPP).

The process conditions are set forth in Table 1.

### COMPARATIVE EXAMPLE 2

The same procedure as detailed hereinabove for the manufacture of the polymers (VDF) of any of Examples 1-4 according to the invention was repeated but replacing Na₄(P₂O₇) (TSPP) with (NH₄)₂HPO₄ in an amount of 0.6 g/Kg of water.

The process conditions are set forth in Table 1.

### Comparative Example 3

A sequence of 2320 g of demineralized water, 1.45 g of tetrasodium pyrophosphate and 0.64 g of METHOCEL® K100 cellulose ether as suspending agent were introduced in a 4 liter reactor.

The mixture was stirred with an impeller running at a speed of 880 rpm.

The reactor was purged with a sequence of vacuum (30 mmHg) and N₂ (fixed at 1 bar) at a fixed temperature of 20° C. This sequence was done 3 times.

1.12 g of t-amyl perpivalate as radical initiator were added to the reactor. 100 g of demineralized water was used for cleaning all the introduction line.

1070 g of initial VDF were introduced in the mixture. The reactor was gradually heated until the first set-point temperature fixed at 52° C. At this temperature, the pressure was fixed at 120 bar. The pressure was kept constantly equal to 120 bar by feeding in total 53 g of VDF.

When 15% of polymerization conversion rate was reached, 112.5 g of ethyl acetate as chain transfer agent was injected quickly in the reactor followed by 200 g of VDF in order to maintain the pressure in the reactor constantly equal to 120 bar. After this feeding, no more monomer was added and the pressure was decreased to 90 bar. The reactor was then gradually heated to 67° C. The pressure was kept at 80 bar and 287 g of VDF were fed to the reactor. The pressure was then decreased down to 55 bar. A conversion of 85% of VDF was reached. The polymerization was stopped by degassing the reactor until reaching the atmospheric pressure. The VDF homopolymer was collected by filtration and was washed with demineralized water. After the washing step, the polymer powder was dried at 65° C. overnight.

The process conditions are set forth in Table 1.

### COMPARATIVE EXAMPLE 4

The same procedure as detailed hereinabove for the manufacture of the polymers (VDF) of any of Examples 1-4 according to the invention was repeated but replacing Na₄(P₂O₇) (TSPP) with (NH₄)₂CO₃ in an amount of 1.66 g/Kg of water.

The process conditions are set forth in Table 1.

### COMPARATIVE EXAMPLE 5

A sequence of 2320 g of demineralized water, 0.385 g/Kg of water of pyrophosphoric acid (H₄P₂O₇), 0.385 g/Kg of water of Na₄(P₂O₇) (TSPP) and 0.64 g of METHOCEL® K100 cellulose ether as suspending agent were introduced in a 4 liter reactor. The mixture was stirred with an impeller running at a speed of 880 rpm.

The reactor was purged with a sequence of vacuum (30 mmHg) and N₂ (fixed at 1 bar) at a fixed temperature of 20° C. This sequence was done 3 times.

32.1 g of diethyl carbonate as chain transfer agent and 1.12 g of t-amyl perpivalate as radical initiator were added to the reactor. The introduction line was washed with 100 g of water.

1070 g of initial VDF were introduced in the mixture. The reactor was gradually heated until the first set-point temperature fixed at 52° C. At this temperature, the pressure was fixed at 120 bar. The pressure was kept constantly equal to 120 bar by feeding in total 250 g of VDF during the polymerization. After this feeding, no more monomer was added and the pressure was decreased to 90 bar. The reactor was then gradually heated to 67° C. The pressure was kept at 80 bar and 287 g of VDF were fed to the reactor. The pressure was then decreased down to 55 bar. The polymerization was stopped by degassing the reactor until reaching the atmospheric pressure. A conversion of 87.5% of VDF was reached. The polymer was collected by filtration and washed with demineralized water. After the washing step, the polymer powder was dried at 65° C. overnight.

The process conditions are set forth in Table 1.

General Procedure for the Extrusion of Polymer (VDF) in Pellets

The process was carried out using a twin screw co-rotating extruder (Leistritz LSM 30.34 GG-5R having a screw diameter D of 34 mm), equipped with a main feeder, having six temperature controlled zones that permit to set the desired temperature profile. The die was composed of two holes having each a diameter of 4 mm. The two extrudates were cooled in a water tank, pull out and then dried with compressed air. At the end, the two extrudates were cut-off in order to obtain the pellets.

TABLE 1

| | | Salt | Na+ | (P₂O₇)₄₋ | |
|---|---|---|---|---|---|
| | CTA | [g/kg | [g/kg | [g/kg | pH |
| Run | [g/kg MnT] a) | water] | water] | water] | b) |
| Ex. 1 | Diethyl carbonate | TSPP | 0.14 | 0.26 | 7.7 |
| | 20 | 0.4 | | | |
| Ex. 2 | Diethyl carbonate | TSPP | 0.28 | 0.52 | 8.1 |
| | 20 | 0.8 | | | |
| Ex. 3 | Diethyl carbonate | TSPP | 0.02 | 0.03 | 4.6 |
| | 20 | 0.05 | | | |
| Ex. 4 | Ethyl acetate | TSPP | 0.21 | 0.39 | 6.5 |
| | 26.7 | 0.6 | | | |
| C. Ex. 1 | Diethyl carbonate | — | — | — | 3.9 |
| | 20 | | | | |
| C. Ex. 2 | Diethyl carbonate | (NH₄)₂HPO₄ | | — | 7.4 |
| | 20 | 0.6 | | | |
| C. Ex. 3 | Ethyl acetate | TSPP | 0.21 | 0.39 | 6.3 |
| | 70 | 0.6 | | | |
| C. Ex. 4 | Diethyl carbonate | (NH₄)₂CO₃ | — | — | 8.9 |
| | | 1.66 | | | |
| C. Ex. 5 | Diethyl carbonate | TSPP/H₄P₂O₇ | — | — | 3.0 |
| | | 0.385/0.385 | | | |

a) MₙT is the total amount of monomer introduced during polymerization;
b) pH measurement at the end of the polymerization.

As shown in Table 2, the polymers (VDF) according to the invention as notably represented by the polymers (VDF) of any of Examples 1 to 4 according to the invention are advantageously endowed with values of TOO lower than 10 as compared to known polymers obtained according to any of Comparative Examples 1 to 5.

Also, as shown in Table 2, the polymers (VDF) according to the invention as notably represented by the polymers (VDF) of any of Examples 1 to 4 according to the invention advantageously exhibit values of White Index (WI) higher than 50.

Further, as shown in Table 2, the polymers (VDF) according to the invention as notably represented by the polymers (VDF) of any of Examples 1 to 4 according to the invention advantageously have an amount of reversed VDF-VDF dyads of less than 4.5% and are thus endowed with good mechanical properties.

TABLE 2

| | TOC | | Reversed dyads |
|---|---|---|---|
| Run | [mg/kg] | WI | (H-H/H-T) |
| Ex. 1 | 6.9 | 58.2 | 4.4 |
| Ex. 2 | 7.2 | 57.7 | 4.4 |
| Ex. 3 | 9.3 | 56.2 | 4.4 |
| Ex. 4 | 8.6 | 57.3 | 4.4 |
| C. Ex. 1 | 14 | 57.7 | 4.3 |
| C. Ex. 2 | 16 | 20.2 | — |
| C. Ex. 3 | 18 | 38 | — |
| C. Ex. 4 | 11.5 | 42.2 | — |
| C. Ex. 5 | 18 | 56.8 | — |

1. A process for manufacturing a polymer (VDF), wherein polymer (VDF) is a vinylidene fluoride polymer, said process comprising polymerizing vinylidene fluoride (VDF) and, optionally, at least one fluorinated monomer different from VDF in an aqueous medium having a pH of at least 4, said aqueous medium comprising, preferably consisting of:
water,
at least one salt comprising at least one salt (AM) wherein salt (AM) is an alkaline metal cation, said salt (AM) being free from one or more protons (H⁺), and
optionally, at least one suspending agent,
in the presence of at least one radical initiator and at least one chain transfer agent, wherein said at least one chain transfer agent is added to said aqueous medium prior to or together with said at least one radical initiator.

2. The process according to claim 1, wherein the salt (AM) comprises at least one alkaline metal cation and an organic or inorganic anion.

3. The process according to claim 1, wherein the salt (AM) comprises at least one alkaline metal cation selected from the group consisting of Li⁺, Na⁺ and K⁺ cations.

4. The process according to claim 1, wherein the salt (AM) is selected from the group consisting of tetrasodium pyrophosphate (TSPP) of formula Na₄(P₂O₇), Na₃PO₄, Na₂CO₃ and mixtures thereof.

5. The process according to claim 1, wherein the aqueous medium comprises at least one salt (AM) in an amount comprised between 0.05 and 5 g/Kg of water.

6. The process according to claim 1, wherein the suspending agent is selected from the group consisting of polysaccharide derivatives.

7. The process according to claim 6, wherein the polysaccharide derivative comprises glycosidic units selected from D-glucopyranosides and D-glucofuranosides, or a mixture thereof, linked to each other by glycosidic bonds.

8. The process according to claim 1, wherein the chain transfer agent is selected from the group consisting of:
(i) organic carbonates of formula (II-a):
R′₁—O—CO—O—R′₂ (II-a)
wherein R′₁ and R′₂, equal to or different from each other, are C₁-C₁₀ alkyl groups, and
(ii) alkyl acetates of formula (II-b):
R″₁—CO—O—CH₃ (II-b)
wherein R″₁ is a C₁-C₁₀ alkyl group.

9. A polymer (VDF), wherein polymer (VDF) is a vinylidene fluoride polymer comprising recurring units derived from vinylidene fluoride (VDF) and, optionally, at least one fluorinated monomer different from VDF, said polymer (VDF) comprising recurring units derived from one or more head-to-head or tail-to-tail VDF-VDF dyads in an amount of less than 4.5%, with respect to the total amount of recurring units.

10. The polymer (VDF) according to claim 9, said polymer (VDF) having values of Total Organic Content (TOC) lower than 10 mg/Kg of said polymer (VDF).

11. The polymer (VDF) according to claim 9, said polymer (VDF) having an intrinsic viscosity comprised between 0.06 and 0.13 l/g.

12. An article comprising at least one polymer (VDF) according to claim 9.

13. The article according to claim 12, said article being selected from the group consisting of films, plaques, pipes and fittings.

14. The process according to claim 5, wherein the aqueous medium comprises at least one salt (AM) in an amount comprised between 0.1 and 2 g/Kg of water.

15. The process according to claim 5, wherein the aqueous medium comprises at least one salt (AM) in an amount comprised between 0.3 and 0.8 g/Kg of water.

16. The process according to claim 8, wherein R′₁, R′₂, R″₁ equal to or different from each other, are C₁-C₅ alkyl groups.

17. The polymer (VDF) according to claim 10, said polymer (VDF) having values of Total Organic Content (TOC) lower than 9 mg/Kg of said polymer (VDF).

18. The polymer (VDF) according to claim 10, said polymer (VDF) having values of Total Organic Content (TOC) lower than 8 mg/Kg of said polymer (VDF).

19. The polymer (VDF) according to claim 11, said polymer (VDF) having an intrinsic viscosity comprised between 0.07 and 0.12 l/g.

20. The polymer (VDF) according to claim 11, said polymer (VDF) having an intrinsic viscosity comprised between 0.08 and 0.11 l/g.
